(19) United States
(12) Patent Application Publication
(10) Pub. No.: US 2010/0149639 A1
(43) Pub. Date: Jun. 17, 2010

(54) RETRO-REFLECTOR USED IN TRAFFIC SAFETY SIGNS

(76) Inventor: Bongju Kim, Seoul (KR)

Correspondence Address: IPLA P.A., 3550 WILSHIRE BLVD., 17TH FLOOR, LOS ANGELES, CA, 90010, US

(21) Appl. No.: 12/161,807

(22) PCT Filed: Jan. 23, 2007
(86) PCT No.: PCT/KR07/00398

§ 371 Date: Jul. 23, 2008

(30) Foreign Application Priority Data
Jan. 23, 2006 (KR) 10-2006-0007038

(51) Int. Cl. G02B 5/124

(52) U.S. Cl. 359/530

(57) ABSTRACT

A retro-reflector has at least one retro-reflecting element that has high retro-reflection efficiency and a very wide retro-reflecting range. The retro-reflecting element includes a mother reflecting corner including a communal reflecting surface that is an optical surface of a single geometrical plane, and a conceptual stepped surface that meets the communal reflecting surface at a right angle; and a plurality of subsidiary reflecting corners that are arranged along the stepped surface such that corners thereof meet the communal reflecting surface at a right angle, and each including a pair of exclusive reflecting surfaces, which are optical surfaces in a single geometrical plane and meet at a right angle.

### TECHNICAL FIELD

The present invention relates, in general, to a retro-reflector used in traffic safety signs having at least one retro-reflecting element capable of retro-reflecting incident light in the direction from which the light was radiated, and more particularly, to a retro-reflector which is installed or attached so as to retro-reflect light in the direction from which the light was radiated in order to increase the nighttime visibility of various traffic safety installations or objects, particularly having high retro-reflection efficiency and a wide visible retro-reflection range.

### BACKGROUND ART

A variety of traffic safety installations such as traffic signs, pavement markers, delineators, tripods, etc. or objects such as safety clothes, bicycles, helmets, shoes, etc., which must be visible at night, have used in traffic safety signs a retro-reflector installed or attached thereto, so that the visibility of the objects is increased by retro-reflecting light incident from the front toward the light source radiating the light.

Conventionally, retro-reflectors used in traffic safety signs applied to such objects are ones having glass beads or corner cubes.

However, these conventional retro-reflectors have a problem in that the retro-reflection ratio, expressed as the ratio of the quantity of incident light to the quantity of retro-reflected light, is low, and is sharply reduced as the incident angle of the light is increased, and thus the retro-reflection range is narrow.

For example, in the case of the conventional retro-reflector using glass beads, because the light incident on the edges of the glass beads or into gaps between the glass beads is not retro-reflected, there is a problem in that the overall retro-reflection ratio is lowered, and thus brightness is low.

In the case of the conventional retro-reflector using corner cubes, the overall retro-reflection ratio is high compared to the conventional retro-reflector using glass beads. However, when the incident angle of the light becomes large due to movement of the light source, the apparent area of the exposure surface (i.e. the area of the exposure surface when viewed from the direction of the light source) has no alternative but to be geometrically reduced. At this time, because the percentage of the retro-reflection area capable of retro-reflecting the light incident on the exposure surface is further reduced, the conventional retro-reflector using corner cubes has a problem in that the brightness is sharply lowered in proportion to the magnitude of the incident angle. Therefore, the retro-reflection range of the incident angle, i.e. the visible retro-reflection range, is very narrow, and a retro-reflector capable of retro-reflecting light having a large incident angle, which is deflected off the front of the exposure surface in a specific direction at an angle greater than a predetermined angle, is very difficult to design and fabricate.

### DISCLOSURE OF INVENTION

### Technical Problem

Accordingly, the present invention has been made in an effort to solve the problems occurring in the related art, and an object of the present invention is to provide a retro-reflector used in traffic safety signs in which the retro-reflection ratio is slightly reduced when the incident angle of incident light is increased, and thus is high overall with respect to light incident from any angle.

Another object of the present invention is to provide a retro-reflector in which the direction of a visible retro-reflection range is easily varied in a design step, and thus can be freely varied without restriction of the angle from the front of an exposure surface (i.e. the surface exposed to a light source).

### Technical Solution

In order to achieve the above objects, according to one aspect of the present invention, there is provided a retro-reflector used in traffic safety signs having at least one retro-reflecting element that has high retro-reflection efficiency and a very wide retro-reflecting range. Each retro-reflecting element includes a mother reflecting corner including a communal reflecting surface, which is an optical surface formed as a single geometrical plane, and a conceptual stepped surface that meets the communal reflecting surface at a right angle; and a plurality of subsidiary reflecting corners that are arranged along the stepped surface such that corners thereof meet the communal reflecting surface at a right angle, and each including a pair of exclusive reflecting surfaces that are the optical surfaces of a single geometrical plane and meet at a right angle.

Here, the stepped surface may be formed as a conceptual surface selected from a flat surface, a curved surface, and a polygonal surface, in which a plurality of flat surfaces is combined. The mother reflecting corner and each subsidiary reflecting corner may each have an aspect ratio of less than 1.

Further, the mother reflecting corner and each subsidiary reflecting corner may each have a corner direction that is deflected relative to the normal of a corner incident plane thereof at a deflection angle of less than 45 degrees.

The retro-reflector according to the present invention has a wide retro-reflective region, and thus a high retro-reflection ratio, defined as the ratio of the quantity of incident light to the quantity of retro-reflected light, compared to the conventional retro-reflector, which uses corner cubes or glass beads. Further, the inventive retro-reflector has a wide retro-reflection range because the retro-reflection ratio is slowly reduced although the incident angle of incident light is increased. In addition, the main reflection direction, which has the highest retro-reflection ratio, is easily varied, and the angularity, defined as the retro-reflection performance of incident light having a predetermined incident angle or a greater incident angle, is very good.

### Advantageous Effects

In order to accomplish these objects, the retro-reflector used in traffic safety signs according to the present invention has at least one retro-reflecting element that has high retro-reflection efficiency and a very wide retro-reflecting range. The retro-reflecting element includes a mother reflecting corner including a communal reflecting surface, which is an optical surface formed as a single geometrical plane, and a conceptual stepped surface that meets the communal reflecting surface at a right angle; and a plurality of subsidiary reflecting corners that are arranged along the stepped surface such that corners thereof meet the communal reflecting surface at a right angle, and each including a pair of exclusive reflecting surfaces that are optical surfaces in a single geometrical plane, and meet at a right angle.

Here, the stepped surface can be formed into a conceptual surface selected from a flat surface, a curved surface, and a polygonal surface, in which a plurality of flat surfaces is combined. The mother reflecting corner and each subsidiary reflecting corner can each have an aspect ratio of less than 1.

Further, the mother reflecting corner and each subsidiary reflecting corner can each have a corner direction that is deflected with respect to the normal of a corner incident plane thereof at a deflection angle of less than 45 degrees.

The inventive retro-reflector has a wide retro-reflective region, and thus a high retro-reflection ratio, defined as the ratio of the quantity of incident light to the quantity of retro-reflected light, compared to the conventional retro-reflector which uses corner cubes or glass beads. Further, the inventive retro-reflector has a wide retro-reflection range because the retro-reflection ratio is only slightly reduced when the incident angle of incident light is increased. In addition, the main reflection direction, which has the highest retro-reflection ratio, is easily varied, and angularity, which is defined as the retro-reflection performance of the incident light having a predetermined incident angle or greater, is excellent.

### BRIEF DESCRIPTION OF DRAWINGS

FIG. 1 is a perspective view illustrating a retro-reflector according to a first embodiment of the present invention;

FIG. 2 is a cross-sectional view illustrating a retro-reflector according to an embodiment of the present invention;

FIG. 3 is a sectional view taken along line X-X of FIG. 2;

FIG. 4 is an enlarged perspective view illustrating a retro-reflection path of a retro-reflector according to a first embodiment of the present invention;

FIGS. 5 and 6 are enlarged views illustrating the comparison between a significant retro-reflective region of a retro-reflector according to a first embodiment of the present invention and that of a conventional retro-reflector using corner cubes;

FIG. 7 is a perspective view illustrating a retro-reflector according to a second embodiment of the present invention;

FIG. 8 is a plan view illustrating a retro-reflector according to a second embodiment of the present invention;

FIG. 9 is a sectional view taken along line X-X of FIG. 8;

FIG. 10 is a perspective view illustrating a total-reflection prism;

FIG. 11 is a side sectional view illustrating a total-reflection prism;

FIG. 12 is a front view illustrating a retro-reflector according to a third embodiment of the present invention;

FIG. 13 is a sectional view taken along line X-X of FIG. 12;

FIG. 14 is a sectional view taken along line Y-Y of FIG. 12;

FIG. 15 is a sectional view taken along line y-y of FIG. 12;

FIG. 16 is a plan view illustrating a retro-reflector according to a fourth embodiment of the present invention;

FIG. 17 is a sectional view taken along line X-X of FIG. 16;

FIG. 18 is a plan view illustrating a retro-reflector according to a fifth embodiment of the present invention;

FIG. 19 is a sectional view taken along line X-X of FIG. 18;

FIG. 20 is a front perspective view illustrating a retro-reflector according to a sixth embodiment of the present invention;

FIG. 21 is a sectional view taken along line X-X of FIG. 20;

FIG. 22 is a sectional view taken along line Y-Y of FIG. 21;

FIG. 23 is a plan view illustrating a retro-reflector according to a seventh embodiment of the present invention;

FIG. 24 is a sectional view taken along line X-X of FIG. 23;

FIG. 25 is a front perspective view illustrating a retro-reflector according to an eighth embodiment of the present invention;

FIG. 26 is a sectional view of FIG. 25;

FIG. 27 is a plan view of FIG. 25;

FIG. 28 is a plan view illustrating a retro-reflector according to a ninth embodiment of the present invention;

FIG. 29 is a sectional view taken along line Y-Y of FIG. 28;

FIG. 30 is a sectional view taken along line X-X of FIG. 28;

FIG. 31 is a plan view illustrating a retro-reflector according to a tenth embodiment of the present invention;

FIG. 32 is a sectional view taken along line F-F of FIG. 31;

FIG. 33 is a perspective view illustrating a road on which a pavement marker according to an eleventh embodiment of the present invention is installed; and

FIG. 34 is a perspective view illustrating a pavement marker according to an eleventh embodiment of the present invention.

### MODE FOR THE INVENTION

Hereinafter, reference will be made in greater detail to various embodiments of a retro-reflector according to the invention.

### Embodiment 1

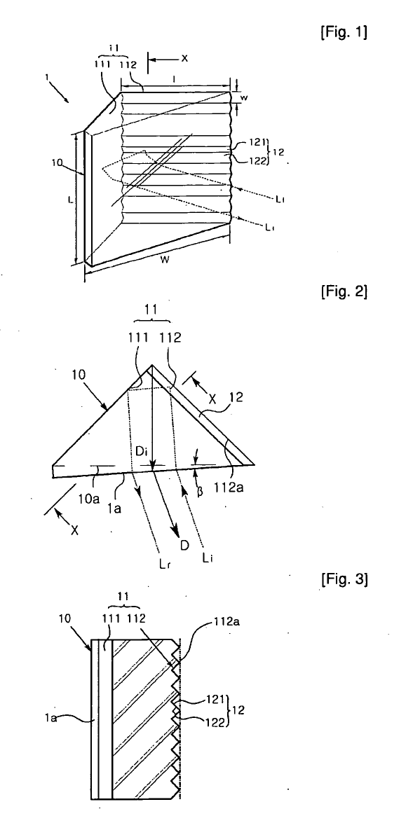

FIG. 1 is a perspective view illustrating a retro-reflector according to a first embodiment of the present invention. FIG. 2 is a cross-sectional view illustrating a retro-reflector according to an embodiment of the present invention. FIG. 3 is a sectional view taken along line X-X of FIG. 2.

The retro-reflector according to the present invention is generally made of an optically transparent material such as glass, crystal, polymethyl methacrylate (PMMA), polycarbonate, ultraviolet (UV)-cured resin, acryl, and so on.

As illustrated in FIGS. 1, 2 and FIG. 3, the retro-reflector according to the first embodiment is formed with a single retro-reflection element 10 at the rear thereof. The retro-reflection element 10 is a combination of two kinds of reflecting corners, i.e. a mother reflecting corner 11 and subsidiary reflecting corners 12.

The mother reflecting corner 11 includes a communal reflecting surface 111, which is an optical surface formed as a single geometrical plane, and a stepped surface 112a, which is a conceptual surface that meets the communal reflecting surface 111 at a right angle. The subsidiary reflecting corners 12 are reflecting corners that are longitudinally formed on the stepped surface 112a in a row, wherein each of the reflecting corners is an optical surface formed as a single geometrical plane, and is composed of a pair of exclusive reflecting surfaces 121 and 122 that meet at a right angle.

The retro-reflection element 10 has a retro-reflection structure in which two reflecting structures (which will be described in detail) of the total-reflection prism, which is designed to carry out total reflection using two reflecting surfaces that meet at a right angle, are combined, i.e. a combined total-reflection prism type retro-reflection structure in which the subsidiary reflecting corners 12, each of which includes two exclusive reflecting surfaces 121 and 122 meeting the stepped surface 112a, acting as any one of the reflecting surfaces of the mother reflecting corner 11 at a right angle, are formed in a row.

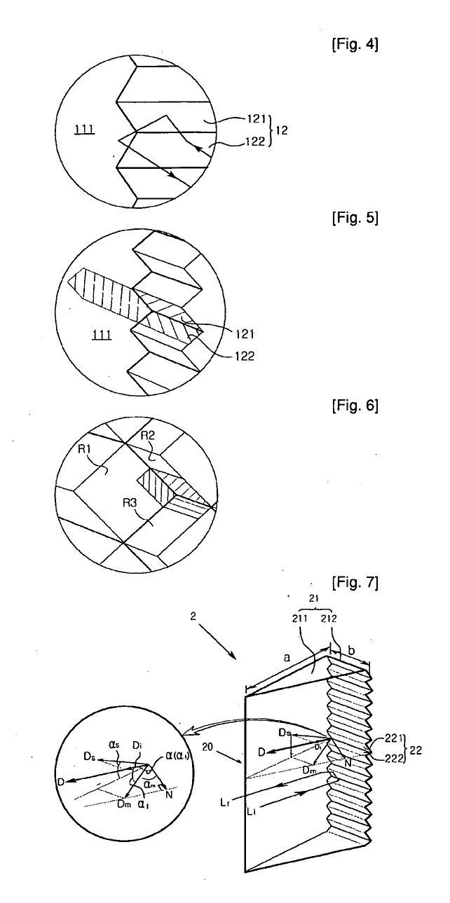

As illustrated in FIG. 4, this retro-reflection element 10 forms a retro-reflection structure such as corner cubes, in which the exclusive reflecting surfaces 121 and 122 of each subsidiary reflecting corner 12 are formed as three reflecting surfaces that meet at a right angle together with the communal reflecting surface 111, thereby retro-reflecting light, which is incident on each of the exclusive reflecting surfaces 121 and 122 or the communal reflecting surface 111, in the direction from which the light was radiated.

Generally, the exclusive reflecting surface 121 or 122 of each subsidiary reflecting corner 12 and the communal reflecting surface 111 are formed so as to meet each other at an interfacial angle of about 90 degrees. However, the interfacial angle between the reflecting surface 111 and the reflecting surface 121 or 122 can be designed to be less than or greater than 90 degrees within an angular range of less than 3 degrees so as to conically diffuse and reflect reflected light Lr according to the distance between the light source and the observer. In addition, the back surface of each reflecting surface, i.e. the reflecting surface 111 or the reflecting surface 121 or 122 forming the retro-reflection element 10 is coated with a reflecting layer such as a mercury layer or an aluminum layer, which functions to prevent the transmission of incident light, which is incident on each reflecting surface, at an incident angle that is less than a critical angle.

In the retro-reflector according to the present invention, the smaller the aspect ratio W/L of the mother reflecting corner 11 of the retro-reflection element and the aspect ratio w/l of the subsidiary reflecting corner 12 of the retro-reflection element, the better. This is because, when the incident angle of the incident light becomes larger, the smaller the aspect ratio of the reflecting corner is, the smaller the reduction rate of a retro-reflective region (the oblique line region of FIG. 5) of each exclusive reflecting surface 121 or 122 is, thus increasing the retro-reflection ratio. Therefore, each of the aspect ratios W/L and w/l of each reflecting corner is preferably less than 1, and more preferably less than 0.5.

Meanwhile, the retro-reflector according to the present invention can be made in a form having no medium, for instance in the form of a metal sheet having only the retro-reflection element, by pressing a metal sheet or die-casting a glossy material.

In this retro-reflector according to the present invention, when the incident angle of the incident light Lᵢ is increased due to the movement of the light source (e.g. automobile headlights), the retro-reflection ratio, defined as the ratio of the quantity of incident light Lᵢ to the quantity of retro-reflected light Lᵣ is remarkably high compared to the retro-reflectors using glass beads as well as to the retro-reflectors using corner cubes, and thus the brightness is very high.

In FIGS. 5 and 6, the retro-reflective regions of the retro-reflector according to the present invention and the retro-reflectors using corner cubes are shown as having the same incident angle.

As illustrated in FIG. 5, in the case where the refractive index and the incident angle are the same, the retro-reflector of the present invention is still higher in the percentage of a retro-reflective region, i.e. in the percentage of a retro-reflective region (an oblique line region) with respect to the apparent area (of the retro-reflection element when viewed from the light source), compared to conventional retro-reflectors using corner cubes illustrated in FIG. 6, so that it has a better retro-reflection ratio and a wider visible retro-reflection range compared to conventional retro-reflectors.

In general, in the case of the retro-reflector, the percentage of a retro-reflecting area is varied according to the incident direction of the incident light, and thus the retro-reflection ratio is varied. Thus, the main reflection direction D of each retro-reflector is that the retro-reflection ratio is the highest.

As illustrated in FIG. 6, the conventional retro-reflectors using corner cubes include reflecting surfaces R₁, R₂ and R₃ having corner cubes of the same size and shape, so that the retro-reflection ratio is highest for light that is incident parallel to the optical axis, defined as a straight line connecting the center of each reflecting surface of the corner cube. Therefore, the conventional retro-reflectors using corner cubes generally have an optical axis corresponding to a main reflection direction. Because it is very difficult to change the direction of the optical axis in the design step, the main reflection direction D does not greatly deviate from the normal direction relative to the plane that is exposed to the light source. Further, as can be seen from FIG. 6, when the incident angle of the light is increased, the retro-reflecting region (oblique line region) of the light source-side reflecting surfaces R₂ and R₃ is sharply reduced. For this reason, the retro-reflection ratio is greatly reduced, and thus the reflected visual range, in which retro-reflection is possible, is very narrow.

In contrast, the retro-reflector according to the present invention can be varied without restriction as to the angle thereof by adjusting easily variable design factors such as the slope β the corner direction Dₘ of the mother reflecting corner, and the corner direction Dₛ of each subsidiary reflecting corner of an incident plane 10a of the retro-reflection element with respect to the exposure surface 1a, and thus has an advantage in that various retro-reflectors in which the main reflection direction D is varied according to a relative position of the light source can be fabricated.

<Definition of Terms>

Reflecting corner: reflecting structure formed by two optical planes, which are planes in the geometrical sense, meeting at a right angle.

Stepped surface: conceptual surface on which the reflecting corners are arranged.

Main reflection direction: incident direction in which the retro-reflection efficiency is the maximum.

Corner direction: direction of a central line connecting a corner of the reflecting corner to the middle point M between the outer sides of two reflecting planes R₁ and R₂.

Optical axis: straight line connecting the centers of optical planes contacting each other.

Internal main reflection direction: incident direction in a medium, the retro-reflection ratio of which is the maximum.

exposure surface: surface of the retro-reflector exposed to the light source.

Incident angle: inclined angle of incident light relative to the normal of the plane onto which the light is incident

Element incident plane: conceptual plane connecting the outer side of the communal reflecting surface and the outer side of the stepped surface in the retro-reflection element.

Corner incident plane: conceptual plane connecting the outer sides of two reflecting surfaces in the reflecting corner.

### Embodiment 2

The retro-reflector illustrated in FIG. 7 represents a second embodiment. In this retro-reflector, the main reflection direction D, in which retro-reflection efficiency is highest, deviates from the normal N, i.e. the front direction, of an exposure surface 2a in a specific direction.

FIG. 10 shows a total-reflection prism P having two reflecting surfaces R₁ and R₂ meeting at a right angle, wherein the total-reflection prism P can retro-reflect light incident onto an incident plane F by means of a reflecting corner C formed by the two reflecting surfaces R₁ and R₂ in a projected direction.

The reflection ratio of the total-reflection prism P varies according to the incident angle, and to the total-reflection direction D, capable of reversely reflecting all incident light in the projected direction.

The total-reflection prism P can perform total reflection on the incident light, that is, primarily reflected light, traveling parallel to the incident plane F. In other words, as illustrated in FIG. 11, the total-reflection prism P can perform total reflection on the incident light Lᵢ, the reflection angle θᵣ of which is equal to the angle, i.e. θ, between the reflecting surface R₁ on which the light is primarily reflected and the incident plane F when the light is primarily reflected on any one R₁ of the reflecting surfaces. The incident direction of the incident light Lᵢ is defined as the total-reflection direction D of the total-reflection prism P.

As can be seen from FIG. 11, the total-reflection direction D of the total-reflection prism P geometrically varies according to the corner direction D_{c}, defined as the direction of a central line connecting a corner E between the two reflecting surfaces R₁ and R₂ to the middle point M of the incident plane F, and is optically varied according to the refractive index n of a material. In other words, in the case in which the widths of the two reflecting surfaces R₁ and R₂ are a and b, the deflection angle α_{c} of the total-reflection direction with respect to the normal N of the incident plane F can be obtained using the following equation according to the deflection angle α_{c} of the corner direction D_{c} with respect to the normal N of the incident plane F, which is determined by the width ratio b/a of the two reflecting surfaces, and the refractive index n of a medium complying with Snell's law (n=sin α/sin α_{c}). In the following equation, the symbol θ refers to the angle between the incident plane F and the reflecting surface R₁. The angle θ is equal to magnitudes of the incident angle θᵢ and the reflection angle θᵣ of the light Lᵢ, incident onto the reflecting surface R₁ in the corner direction D_{c} with respect to the reflecting surface R₁.

$$θ = tan \frac{b}{a}$$

$$θ = {θ}_{i} = {θ}_{r}$$

$${α}_{c} = 90 - 2 θ$$

$${α}_{c} = 90 - 2 {Tan}^{- 1} \frac{b}{a}$$

$$n = \frac{sin α}{sin {α}_{c}}$$

$$α = {Sin}^{- 1} \{ n ( 90 - 2 {Tan}^{- 1} \frac{b}{a} ) \}$$

The retro-reflector according to the present invention is one having a retro-reflection element 20 in which the reflecting corners having a reflection structure as in the above-mentioned total-reflection prism P, i.e. a mother reflecting corner 21 and subsidiary reflecting corners 22, are combined, and thus can retro-reflect light incident through the exposure surface 2a by means of the retro-reflection structure, comprising the mother reflecting corner 21 and the subsidiary reflecting corner 22, in a radiated direction

Therefore, in the retro:reflector according to the present invention, the corner direction Dₘ of the mother reflecting corner 21 illustrated in the FIG. 7 and the corner direction Dₛ of each subsidiary reflecting corner 22 according to refractive index of the medium are varied, and a direction and a deflection angle αᵢ the internal main reflection direction Dᵢ of the retro-reflection element 20 are adjusted, so that it can easily be designed so that the main reflection direction D, in which the retro-reflection ratio is highest, and the deflection angle α are changed. In other words, in the design step, the width ratio a/b of a communal reflecting surface 211 and a stepped surface 212 which determines the corner direction Dₘ of the mother reflecting corner 21 as illustrated in FIG. 7, and the width ratio d/c of two exclusive reflecting surface 221 and 222, which determines the corner direction Dₛ of the subsidiary reflecting corner 22, as illustrated in FIG. 9, are adjusted, and thereby the internal main reflection direction Dᵢ of the retro-reflection element 20 is adjusted according to the refractive index n of the medium, so that the main reflection direction D, in which the retro-reflection ratio becomes highest, can be easily varied so as to make it possible to use the retro-reflector without regard to a deflection direction or a deflection angle α.

The retro-reflector according to the second embodiment is one in which the refractive index n of the medium is 1, and in which a single retro-reflection element 20 is formed in contact with the exposure surface 2a, and thus the main reflection direction D is equal to the internal main reflection direction Dᵢ of the retro-reflection element 20.

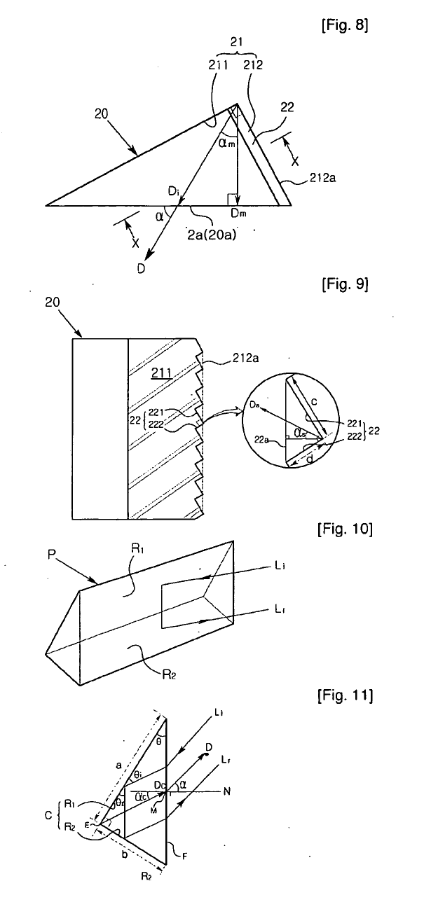

In the retro-reflector 2, the corner direction D of the mother reflecting corner 21 is deflected toward the left side, as illustrated in a cross-sectional view of FIG. 8 (αₘ), and the corner direction Dₛ of each subsidiary reflecting corner 22 formed on each step plane 212a in the same pattern is deflected upwards (αₘ). Thus, as illustrated in FIG. 7, the internal main reflection direction Dᵢ of the retro-reflection element 20 and the main reflection direction D, which have the same direction, are deflected toward the upper left side with respect to the normal N of the exposure surface 20a, so that the light incident from the upper left side can be retro-reflected at the highest ratio.

As can be seen from the retro-reflector of the second embodiment, when designing the retro-reflector according to the present invention, the deflection direction and the deflection angle αᵢ of the internal main reflection direction Dᵢ of the retro-reflection element 20 can be adjusted using the width ratio b/a of the reflecting surface of the mother reflecting corner 21 and the width ratio d/c of the reflecting surface of each subsidiary reflecting corner 22 according to the refractive index n of the medium, so that the designed main reflection direction D and the deflection angle α can be easily changed.

For example, in the case of designing the retro-reflector 2 having a deflection angle α of 90 degrees relative to the main reflection direction D using a glass material in which the refractive index n is 1.5 so as that the light incident is retro-reflected at an incident angle of about 90 degrees, the width ratio b/a of the reflecting surface of the mother reflecting corner 21 of the retro-reflection element 20 and the width ratio d/c of the reflecting surface of each subsidiary reflecting corner 22 of the retro-reflection element 20 should be adjusted such that the deflection angle αᵢ of the internal main reflection direction Dᵢ of the retro-reflection element 20 with respect to the exposure surface 20a amounts to 41.81 degrees by adjusting the width ratio b/a of the reflecting surface of the mother reflecting corner 21 of the retro-reflection element 20, the width ratio d/c of the reflecting surface of each subsidiary reflecting corner 22 of the retro-reflection element 20, and so on.

$$n = \frac{sin α}{sin {α}_{i}} = \frac{sin 90}{sin {α}_{i}}$$

$$n = \frac{sin α}{sin {α}_{i}}$$

$${α}_{i} = {Sin}^{- 1} [ \frac{1}{n} ] = {Sin}^{- 1} [ \frac{1}{1.5} ] = 41.81 °$$

Meanwhile, in the case of designing the retro-reflector according to the present invention using a material in which the refractive index is n, because the incident angle of the light incident on the exposure surface 20a does not exceed 90 degrees, the deflection angle αᵢ of the internal main reflection direction Dᵢ of the retro-reflection element 20 is preferably restricted within the range shown in the following equation such that the deflection angle α of the main reflection direction D with respect to the normal N of the exposure surface 20a does not exceed 90 degrees.

$${α}_{i} \leq {Sin}^{- 1} ( \frac{1}{n} )$$

Further, because the retro-reflector is usually fabricated using a material the refractive index of which is 1.4, the deflection angle αᵢ of the internal main reflection direction Dᵢ of the retro-reflection element 20 is preferably designed to be less than 45 degrees, and can be determined using the following equation.

$${α}_{i} \leq {Sin}^{- 1} ( \frac{1}{1.4} ) ≅ 45$$

For reference, to be specific about the deflection angle α of the main reflection direction D of the retro-reflector, illustrated in FIG. 7, according to the second embodiment, when the widths of the communal reflecting surface 211 of each stepped surface 212a of the mother reflecting corner 21 are a and b (a=b), and when the widths of the two exclusive reflecting surfaces 221 and 222 of each subsidiary reflecting corner 22 are c and d (c=d), the deflection angle α is deflected by the deflection angle αₘ of the corner direction Dₘ of the mother reflecting corner 21, which is expressed using the following equation (1), toward a surface 211 having a great width in the transverse direction with respect to the normal N of the element incident plane 20a, and is deflected at an angle (αₗ) of a directional component of the corner direction Dₘ of the mother reflecting corner 21, which can be calculated using equation (3) from the deflection angle αₛ of the corner direction Dₛ of each subsidiary reflecting corner, which is expressed using the following equation (2), toward the exclusive reflecting surface 221 having a great size in a longitudinal direction (in the vertical direction on the drawing).

$$\begin{matrix}{α}_{m} = {Sin}^{- 1} \{ n ( 90 - 2 {Tan}^{- 1} \frac{b}{a} ) \} & ( 1 ) \\ {α}_{s} = {Sin}^{- 1} \{ n ( 90 - 2 {Tan}^{- 1} \frac{d}{c} ) \} & ( 2 ) \\ {α}_{l} = {Tan}^{- 1} [ \frac{b tan {α}_{s}}{\sqrt{( {a}^{2} + {b}^{2} )}} ] & ( 3 )\end{matrix}$$

### Embodiment 3

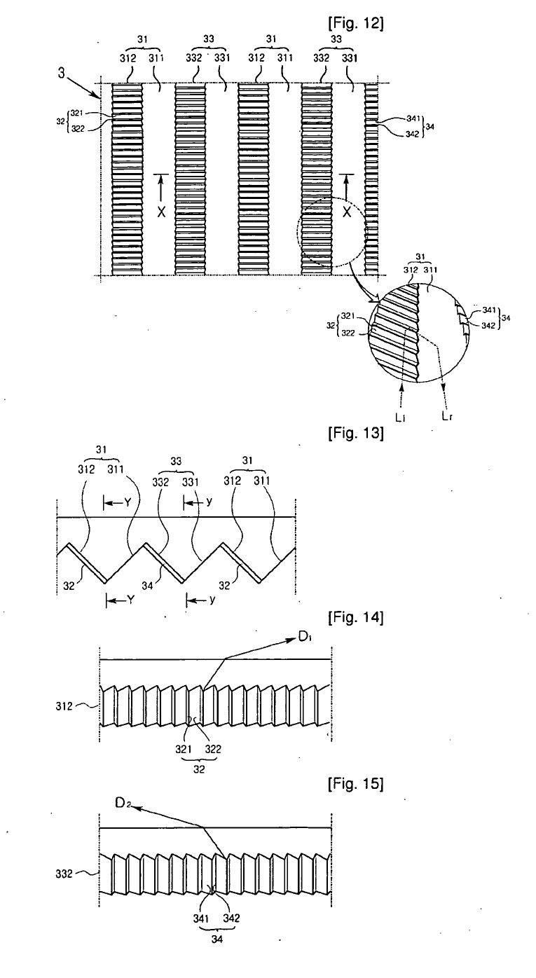

FIG. 12 illustrates a retro-reflector according to a third embodiment, and FIG. 13 is a sectional view taken along line X-X of FIG. 12.

As illustrated, the retro-reflector 3 of the third embodiment is a sheet-shaped retro-reflector in which retro-reflection elements 31 and 33 having a combined prism reflection structure are formed in a uniform pattern, and is generally used as a reflecting means for retro-reflecting incident light in a retro-reflecting film or sheet having a multilayer structure, including a resin layer for protecting surfaces of the retro-reflector, a reflecting layer capable of reflecting light, an adhesive layer for adhering to another object, and so on.

As illustrated in FIGS. 14 and 15, which are sectional views taken along line Y-Y and y-y of FIG. 12, the retro-reflector 3 has two main reflection directions D₁ and D₂, deflection directions of which cross each other and run in opposite directions, because exclusive reflecting surfaces 321 and 322 and exclusive reflecting surfaces 341 and 342 are formed to have a symmetrical structure on the back surface thereof, and thus two kinds of retro-reflection elements 31 and 33, subsidiary reflecting corners 32 and 34 of which have corner directions Dₛ opposite each other, are alternately formed in a transverse direction. This retro-reflector can be retro-reflected in opposite directions, so that it can be used as a mark having increased visibility, for instance, on a road surface on the center line or the crosswalk of a road.

In this embodiment, reflecting surfaces 311 and 331 and stepped surfaces 312 and 332, which form the mother reflecting corner 31 and 33, can be formed to have a symmetrical structure, like the subsidiary reflecting corner 32 and 34.

### Embodiment 4

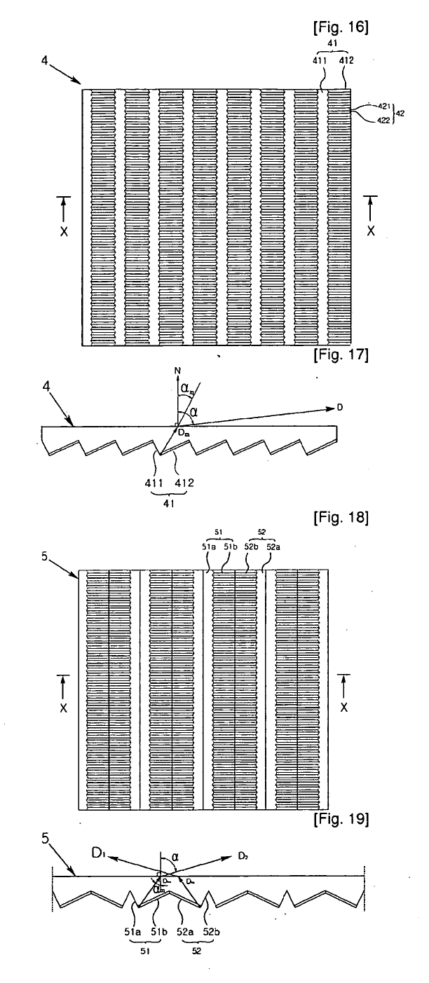

FIG. 16 is a plan view illustrating a retro-reflector according to a fourth embodiment.

The retro-reflector 4 is designed so as to be able to retro-reflect incident light, the incident angle of which is great. As illustrated in FIG. 17, which is a sectional view taken along line X-X of FIG. 16, the corner direction Dₘ of a mother reflecting corner 41 formed by a stepped surface 412 and a communal reflecting surface 411 is deflected on any side (the right side in the drawing), and a main reflection direction D is deflected in the same direction as the corner direction Dₘ of the mother reflecting corner, and is again deflected at a deflection angle α of about 90 degrees according to the refractive index n of a medium. Thus, the retro-reflector 4 of the fourth embodiment can mainly retro-reflect incident light, the main reflection direction D of which is deflected off the normal N of an exposure surface at an angle of about 90 degrees, and thus the incident angle thereof is about 90 degrees. The retro-reflector 4 of the fourth embodiment adjusts the width ratios of exclusive reflecting surfaces 421 and 422 of each reflecting corner 42 (see c and d of FIG. 9), so that it can reflect the main reflection direction D in a transverse direction.

### Embodiment 5

FIG. 18 is a plan view illustrating a retro-reflector according to a fifth embodiment, and FIG. 19 is a sectional view taken along line X-X of FIG. 18.

As illustrated, the retro-reflector 5 according to the fifth embodiment is designed such that communal reflecting surfaces 51a and 52a and stepped surfaces 51b and 52b are formed to have a symmetrical structure on a back surface thereof, and thus two kinds of retro-reflection elements, in which corner directions Dₘ of mother reflecting corners 51 and 52 are opposite each other, are alternately arranged. Thus, the retro-reflector of the fifth embodiment has two main reflection directions D₁ and D₂, deflection directions of which are opposite each other, so that it can perform retro-reflection in opposite directions, like the retro-reflector of the above third embodiment.

### Embodiment 6

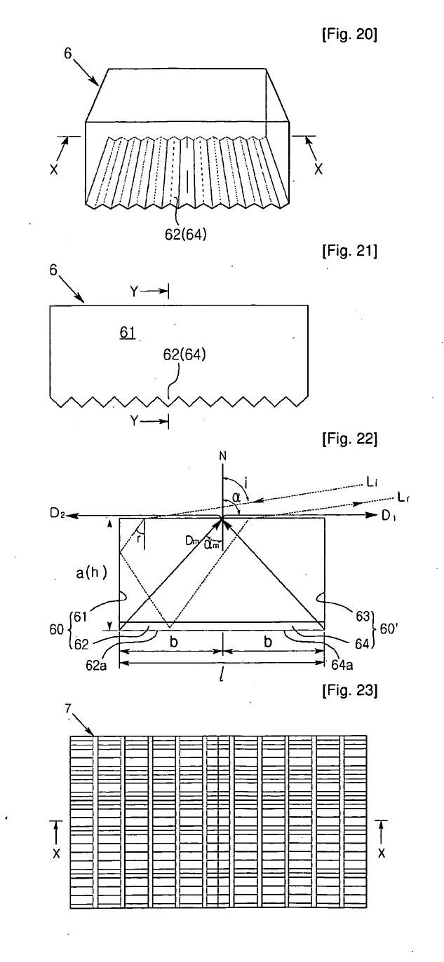

FIG. 20 is a perspective view illustrating a retro-reflector according to a sixth embodiment. FIG. 21 is a sectional view taken along line X-X of FIG. 20. FIG. 22 is a sectional view taken along line Y-Y of FIG. 21.

As illustrated in FIG. 22, the retro-reflector 6 of the sixth embodiment has two main reflection direction D₁ and D₂, deflection directions of which are opposite each other, because two retro-reflection elements 60 and 60′ having a symmetrical structure are laterally formed. In particular, as illustrated in FIGS. 21 and 22, the retro-reflector is fabricated to have a rectangular parallelepiped shape in which subsidiary reflecting corners 62 and 64 of the two retro-reflection elements 60 and 60′, adjacent to each other laterally are formed to be continued on stepped surfaces 62a and 64a, conceptual surfaces, which are located in the same geometrical plane, and communal reflecting surface 61 and 63 of the retro-reflection elements 60 and 60′ are formed on front and rear vertical sides thereof.

This retro-reflector 6 has a structure in which the deflection angle α of the main reflection direction D is mainly dependent on the corner directions Dₘ of mother reflecting corners 61 and 62a and mother reflecting corners 63 and 64a and the refractive index n of a medium. Thus, the width ratio b/a of the reflecting surface 61 or 63 and the stepped surface 62a or 64a, which form the mother reflecting corners 61 and 62a and mother reflecting corners 63 and 64a, which is a design factor determining the deflection angle α of a corner direction, i.e. the ratio of length L and height h in back and forth directions, is adjusted, so that the deflection angles α of the opposite main reflection directions D can be easily varied from 0 degrees to 90 degrees.

Thus, in the case of fabricating the retro-reflector 6 according to the sixth embodiment using a material in which the refractive index is n, the ratio a/b of a width a of the communal reflecting surface 61 or 63 and a width b of the stepped surface 62aor 64a, i.e. the ratio h/l of the height h of the retro-reflector 6 and the length l in lateral directions, is adjusted in the design step, so that the deflection angles α of the main reflection directions D₁ and D₂, applying the refractive index n of the medium to the corner directions Dₘ of the mother reflecting corners 61 and 62a and the mother reflecting corners 63 and 64a, can mainly be matched to the incident angle i of incident light. As a result, the retro-reflector capable of retro-reflecting the incident light Lᵢ incident at a specific incident angle i at a maximum retro-reflection ratio, can be fabricated.

In other words, in the case in which the incident angle i of main incident light is i, the refractive angle r of the light is obtained using Snell's law (n=sin i/sin r), the width ratio b/a of the communal reflecting surface 61 or 63 and the stepped surface 62aor 64a of the retro-reflector in which the deflection angles αₘ of the corner directions Dₘ of the mother reflecting corners 61 and 62a and mother reflecting corners 63 and 64a is equal to the refractive angle r, and the retro-reflector having the height h and the lateral length l matching this width ratio. As a result, the retro-reflector capable of mainly retro-reflecting light having the incident angle i can be fabricated.

$$sin r = \frac{sin i}{n}$$

$$tan {α}_{m} = \frac{b}{α}$$

$${α}_{m} = r$$

$$\frac{b}{a} = tan [ {Sin}^{- 1} ( \frac{sin i}{n} ) ]$$

$$\frac{h}{l} = \frac{a}{2 b}$$

$$\frac{h}{l} = \frac{1}{2} tan [ {Sin}^{- 1} ( \frac{sin i}{n} ) ]$$

For example, in the case of designing and fabricating the retro-reflector according to the sixth embodiment so that it is able to mainly retro-reflect light Lᵢ having an incident angle between about 90 degrees and −90 degrees using glass, the refractive index n of which is 1.5, the ratio of the height and the length can be obtained as follows.

$$\frac{h}{l} = \frac{1}{2} tan [ {Sin}^{- 1} ( \frac{sin 90}{1.5} ) ] = 0.45$$

### Embodiment 7

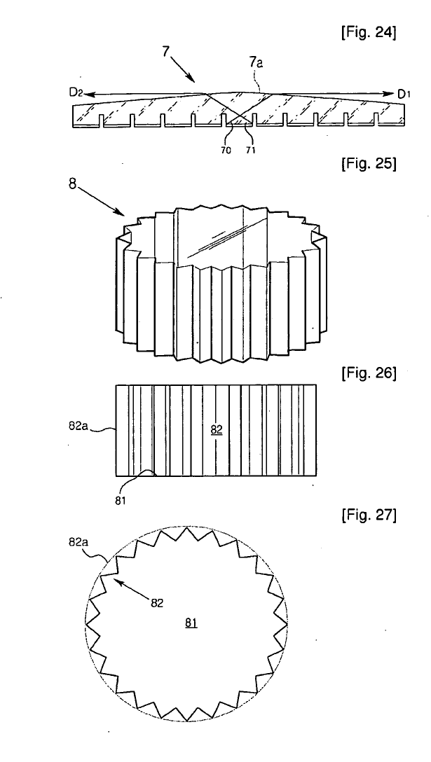

FIG. 23 is a plan view illustrating a retro-reflector according to a seventh embodiment of the present invention, and FIG. 24 is a sectional view taken along line X-X of FIG. 23.

As can be seen from FIGS. 23 and 24, the retro-reflector 7 according to the seventh embodiment is fabricated in the shape of a sheet, and is provided with micro retro-reflection elements 70 and 71, which are located at an underside thereof and have a reflection structure similar to the retro-reflector 6 of the sixth embodiment. An exposure surface 7a is downwardly inclined in opposite directions on the basis of the center of the retro-reflector.

The retro-reflector 7 having this structure can be retro-reflected in opposite directions because it has two main reflection directions D₁ and D₂, and has a high retro-reflection ratio with respect to incident light having a large incident angle because the apparent area of the exposure surface 7a exposed to the incident light having a large incident angle is increased compared to the retro-reflector 6 of the sixth embodiment, in which the exposure surface 7a is a horizontal surface.

### Embodiment 8

FIG. 25 is a perspective view illustrating a retro-reflector according to an eighth embodiment of the present invention, FIG. 26 is a side sectional view illustrating a retro-reflector according to an eighth embodiment of the present invention, and FIG. 27 is a plan view illustrating a retro-reflector according to an eighth embodiment of the present invention.

As can be seen from FIGS. 25 and 26, the retro-reflector 8 according to the eighth embodiment has a structure in which a stepped surface 82a, which acts as a conceptual surface where subsidiary reflecting corners are arranged and meets a communal reflecting surface 81 at a right angle, and forms a mother reflecting corner together with the communal reflecting surface 81, and has a cylindrical shape overall.

The retro-reflector having this structure provides the same retro-reflection structure in a radial direction, so that it can retro-reflect light incident in all directions at the same retro-reflection ratio irrespective of the incident direction.

In the retro-reflector according to the eighth embodiment, the stepped surface 82a can be formed to have a polygonal shape having a plurality of geometrical planes, such as a tetragonal pillar or an octagonal pillar.

### Embodiment 9

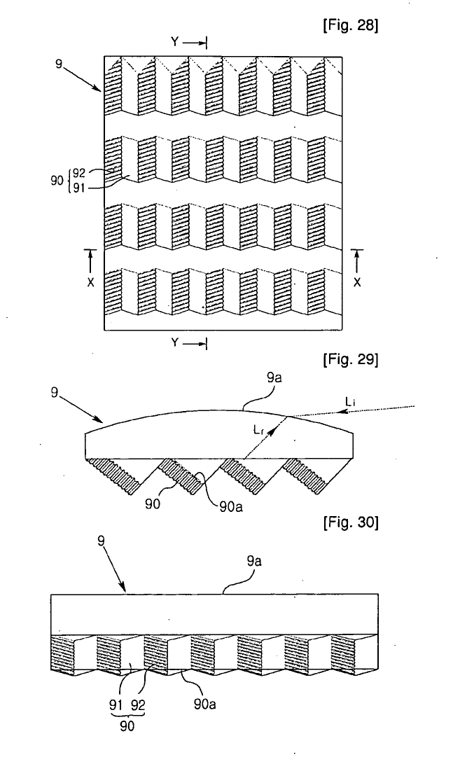

FIG. 28 is a front perspective view illustrating a retro-reflector according to a ninth embodiment of the present invention. FIG. 29 is a side sectional view taken along line Y-Y of FIG. 28. FIG. 30 is a sectional view taken along line X-X of FIG. 28.

The retro-reflector 9 according to the ninth embodiment has a structure in which retro-reflection elements 90 are inclined forwards and upwards on an inclined surface 90a, which is inclined forwards on the underside thereof, and an exposure surface 9a on a top surface thereof is formed to have an arcuate cross section when viewed from the side.

The retro-reflector having this structure has a high retro-reflection ratio with respect to light, the incident direction of which moves upwards by means of movement of a light source, because the exposure surface 9a has an arcuate cross section. Thus, the retro-reflector 9 according to the ninth embodiment can be used for a pavement marker for increasing the visibility of, for instance, the center line or the opposite boundary lines of a road.

### Embodiment 10

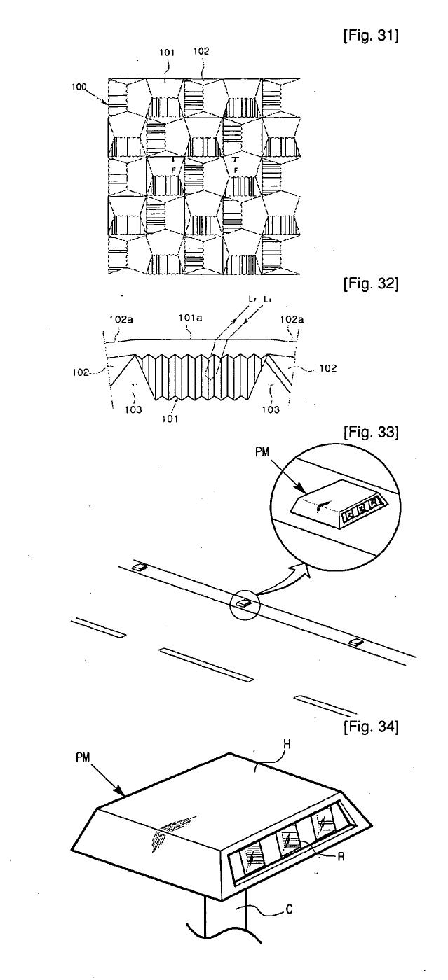

FIG. 31 is a front view illustrating a retro-reflector having a flexible structure between retro-reflection elements according to a tenth embodiment of the present invention, and FIG. 32 is a sectional view taken along line F-F of FIG. 31.

In the retro-reflector 100 according to the tenth embodiment, as an example of a flexible structure, retro-reflection elements 101 and 102 are arranged such that corners of a mother reflecting corner cross each other in transverse and longitudinal directions, so that recesses 103 formed between the retro-reflection elements 101 and 102 impart flexibility to the retro-reflector.

As illustrated in FIG. 32, this retro-reflector bends at the recesses 103 when it must bend in response to longitudinal or transverse flexural stress. Thus, incident planes 101a and 102a on the retro-reflection elements 101 and 102 remain geometrical, so that the retro-reflection ratio is hardly reduced at all.

### Embodiment 11

FIG. 33 is a perspective view illustrating a road having pavement markers, in which a retro-reflector according to the present invention is used as a reflecting means, and FIG. 34 is an enlarged view illustrating a pavement marker.

The retro-reflector according to the present invention can be employed as a reflecting means for improving the visibility of objects, such as various traffic signs or automobiles, which are necessary in order to secure visibility at night or on a rainy day. In FIGS. 33 and 34, as an exemplary application, in order to increase the visibility of a driver with respect to the center line of a road at night or on a rainy day, a pavement marker PM installed along the center line or the outermost lane of a road is illustrated.

As illustrated, the pavement marker PM is typically fixed by a post P buried underground, and is provided with a head H that protrudes upwards from a road surface. The retro-reflector R similar to those 1 and 2 of the first and second embodiments is constructed such that it is installed at the front or rear of the head H, and can retro-reflect light, radiated from the headlights of the automobiles, back toward the driver.

In the pavement marker according to the eleventh embodiment, the retro-reflector R according to the present invention has a structure similar to the retro-reflectors 1 and 2 of the first and second embodiments because a single retro-reflection element is formed on an underside thereof, and is adapted to be buried and fixedly attached to the head H, which is a separate fixing structure.

However, in the case of application to a pavement marker, the retro-reflector R according to the present invention can be fabricated in the shape of a sheet or plate in which a plurality of retro-reflection elements is densely arranged on the underside thereof so that it can be attached to the front or rear of the head H, like the retro-reflectors according to the third through ninth embodiments. Further, like the retro-reflectors according to the seventh through ninth embodiments, the retro-reflector itself is buried underground, so that the retro-reflector can be constructed to function to perform retro-reflection and as a body of the pavement marker.

The embodiments are merely examples proposed to describe the technical spirit of the invention in detail, and thus the present invention may have plenty of applications other than those of the embodiments. Therefore, the embodiments should not be interpreted as having a meaning restricting the technical spirit of the present invention. Consequently, if another technology that is not disclosed herein is included in the basic technical spirit of the present invention, it should be interpreted as falling within the scope of the present invention despite structural differences.

What is claimed is:

1. A retro-reflector used in traffic safety signs having a plurality of retro-reflecting elements, wherein the retro-reflecting elements are densely arranged in a regular pattern on a thin object and each of the retro-reflecting elements includes a mother reflecting corner including a communal reflecting surface which is an optical surface formed as a single geometrical plane and a conceptual stepped surface that meets the communal reflecting surface at a right angle; and a plurality of subsidiary reflecting corners that are arranged along the stepped surface such that corners thereof meet the communal reflecting surface at a right angle, and each including a pair of exclusive reflecting surfaces that are the optical surfaces of a single geometrical plane and meet at a right angle.

2. The retro-reflector as set forth in claim 1, wherein the stepped surface is a conceptual surface selected from a flat surface, a curved surface, and a polygonal surface in which a plurality of flat surfaces are combined.

3. The retro-reflector as set forth in claim 1, wherein the mother reflecting corner has an aspect ratio (W/L) defined as follows:
$$0 < \frac{W}{L} < 1.$$

4. The retro-reflector as set forth in claim 3, wherein the mother reflecting corner has an aspect ratio (W/L) defined as follows:
$$0 < \frac{W}{L} < 0.5 .$$

5. The retro-reflector as set forth in claim 1, wherein each of the subsidiary reflecting corners has an aspect ratio (w/l) defined as follows:
$$0 < \frac{w}{l} < 1.$$

6. The retro-reflector as set forth in claim 5, wherein each of the subsidiary reflecting corners has an aspect ratio (w/l) defined as follows:
$$0 < \frac{w}{L} < 0.5 .$$

7. The retro-reflector as set forth in claim 1, wherein the mother reflecting corners have a corner direction Dₘ that is deflected relative to a normal of a corner incident plane of the mother reflecting corner at a deflection angle αₘ defined as follows:
0<αₘ<45°

8. The retro-reflector as set forth in claim 5, wherein the retro-reflecting elements, in which deflection directions of corner directions of the mother reflecting corner thereof are opposite each other, are alternately arranged.

9. The retro-reflector as set forth in claim 1, wherein each of the subsidiary reflecting corners has a corner direction Dₛ that is deflected relative to a normal of a corner incident plane of the subsidiary reflecting corner at a deflection angle αₛ defined as follows:
0<αₛ<45°

10. The retro-reflector as set forth in claim 9, wherein the subsidiary reflecting corners, in which deflection directions of corner directions of each subsidiary reflecting corner thereof are opposite each other, are alternately arranged.

11. The retro-reflector as set forth in claim 1, wherein, when the retro-reflecting element has a material refractive index of n, the retro-reflecting element has a deflection angle αᵢ of an internal main reflection direction Dᵢ thereof with respect to a normal of an exposure surface, defined as follows:
$$0 < {α}_{i} \leq {Sin}^{- 1} ( \frac{1}{n} ) .$$

12. The retro-reflector as set forth in claim 10, wherein retro-reflecting elements in which deflection directions of main deflection directions thereof are opposite each other are alternately arranged.

13. The retro-reflector as set forth in claim 12, wherein any one of the stepped surfaces and the communal reflecting surfaces of two neighboring retro-reflecting elements is formed on a single plane.

14. The retro-reflector as set forth in claim 1, wherein the retro-reflecting element has an element incident plane that is sloped relative to an exposure surface.

15. The retro-reflector as set forth in claim 1, further comprising a flexible structure allowing the retro-reflector to bend between adjacent retro-reflecting elements.

16. A retro-reflector used in traffic safety signs having at least one retro-reflecting element which includes a mother reflecting corner and a plurality of subsidiary reflecting corners meet the mother reflecting corner at a right angle, wherein, the mother reflecting corners have a corner direction Dₘ that is deflected relative to a normal of a corner incident plane of the mother reflecting corner at a deflection angle αₘ defined as follows:
0<αₘ<45°
